(19) United States
(12) Patent Application Publication
(10) Pub. No.: US 2006/0192159 A1
(43) Pub. Date: Aug. 31, 2006

(54) Pinch valve

(76) Inventor: Frederic Kopp, Trebur-Astheim (DE)

Correspondence Address: John F. McNulty;Paul & Paul, 2900 Two Thousand Market Street, Philadelphia, PA, 19103, US

(21) Appl. No.: 11/359,624

(22) Filed: Feb. 22, 2006

(30) Foreign Application Priority Data
Feb. 25, 2005 (DE) 10 2005 008 648.9

(51) Int. Cl. F16K 7/04

(52) U.S. Cl. 251/5

(57) ABSTRACT

The present invention relates to a pinch valve (1) with a housing which has an inlet (2), an outlet (3) and a control opening (4) for connection to a pressure medium, inlet and outlet being connected to each other via a passage, the passage having at least two sections with a different cross-section (12), and a valve sleeve (16) which is connected to the inlet and outlet and arranged such that it forms a valve channel between inlet and outlet, the valve sleeve (16) moving, upon application of a pressure medium to the control opening (4), such that the channel cross-section between inlet and outlet is reduced or closed. In order to provide a pinch valve can be produced simply and at favourable cost and also seals reliably, it is proposed according to the invention that the housing is formed in at least two parts, one housing part forming the section with a smaller passage cross-section and the other housing part forming the section with a larger passage cross-section.

The present invention relates to a pinch valve. Valves serve in general for the temporary closure or restriction of a material or product flow. In principle, all gases, vapours or liquids, but also granules, pasty materials and other materials come into consideration as product flow. In other words, a valve is an actuator.

Pinch valves have in particular a housing which has an inlet, an outlet and a control opening for connection to a pressure medium. Inlet and outlet are connected to each other via a passage. Arranged inside the housing is a valve sleeve, e.g. an elastomer tube, which is connected to the inlet and the outlet and arranged such that it forms a valve channel between inlet and outlet, the valve sleeve moving, upon application of a pressure medium to the control opening, such that the channel cross-section between inlet and outlet is closed or at least reduced. In other words, the valve sleeve can be compressed by application of a pressure medium, e.g. compressed air, against the control opening such that the sleeve cross-section closes or at least reduces, with the result that the product flow through the valve channel is stopped or at least restricted. If the control opening is released again, the valve channel opens again due to the elastic material properties of the valve sleeve and/or the pressure of the product flow.

The passage formed by the housing generally has at least two sections with different cross-sections. This has the advantage that in general a completely free passage can be formed in the pressureless state, with the result that there is almost no loss of pressure as a result of using a pinch valve. The passage section with a larger passage cross-section forms a control space outside the valve sleeve to which pressure can be applied via the control opening in order to close or restrict the valve.

It is understood that the passage cross-section need not necessarily be circular. When a larger or smaller passage cross-section is mentioned within the framework of this application, it is basically the passage cross-section surface that is meant.

The pinch valve can be used for example to dose or control liquids, suspensions, granules, pastes and other substances. Unlike most other valve types, a perfect sealing-off can also be achieved with the help of a pinch valve when using granules, powders or pastes.

The known pinch valves are often produced from metal materials, the valve body or the valve housing having to be produced by machining due to the “bulbous” structure. Alternative production processes use for example chilled casting, cold pressing or welding. However, these production processes are very laborious and thus involve high costs.

Attempts have already been made to produce a pinch valve from plastic, the valve body or the valve housing being divided in longitudinal direction. The two housing halves were then joined together using screws. However, this pinch valve failed to gain acceptance on the market, owing to persistent leakage problems.

Starting from the described state of the art, it is therefore the object of the present invention to provide a pinch valve that can be produced simply and at favourable cost and also seals reliably.

This object is achieved according to the invention in that the housing is formed in at least two parts, one housing part forming the section with a smaller passage cross-section and the other housing part forming the section with a larger passage cross-section.

The division of the housing is thus substantially in transverse, and not longitudinal, direction.

The multi-part design of the housing such that the division is into sections has the advantage that the individual parts can be formed without “bulges” or undercuts. This makes it possible to produce the housing without machining, which results in considerable savings in production costs.

The housing advantageously has at least three sections, one with the larger passage cross-section and two with the smaller passage cross-section, the sections with the smaller passage cross-section preferably being arranged in the area of the inlet and outlet.

In principle, it is possible to design the housing divided such that one housing part forms a section with the smaller passage cross-section and a section with the larger passage cross-section, while the other housing part forms a housing section with the smaller passage cross-section.

However, it has been shown that there are advantages if the housing is formed in at least three parts, two housing parts forming the sections with the smaller passage cross-section and the third housing part forming the section with the larger passage cross-section.

It is possible for example that the housing is made of a substantially cylindrical main housing part and at least one pressure zone ring, the pressure zone ring being at least partly insertable into the main housing part. The cylindrical main housing part then forms the section with the larger passage cross-section, while the pressure zone ring inserted into the main housing part forms the housing section with the smaller passage cross-section.

It is particularly preferred that in the pressureless state of the control connection the valve channel formed by the valve sleeve has a substantially constant channel cross-section between inlet and outlet.

It is thereby guaranteed that the pinch valve according to the invention can be used without a significant pressure drop occurring.

The control opening is preferably located in the area of the housing section with the larger passage cross-section. As a result, there is formed between valve sleeve on the one hand and inside wall of the housing section with the larger passage cross-section a control space which can be placed under pressure by applying a pressure medium to the control opening and compresses the valve sleeve such that the valve channel cross-section closes or at least reduces.

In a particularly preferred version, a substantially annular control or operating space, to which pressure can be applied via the control opening, is located in the area of the housing section with a larger passage cross-section between valve sleeve on the one hand and housing on the other. As a result of the annular design of the operating space, a reliable and reproducible control of the valve sleeve is guaranteed by the application of pressure.

In a further particularly preferred version, at least the housing part which forms the section with the smaller passage cross-section consists of plastic, preferably thermoplastic material, particularly preferably a polyoxymethylene homo- or copolymerizate.

It is possible in particular to produce the whole housing from plastic, preferably thermoplastic material, particularly preferably a polyoxymethylene homo- or copolymerizate. To produce it from POM has proved particularly advantageous.

The individual housing parts are preferably sealed against one another, for example with the aid of an O-ring. In a variant, the pressure zone ring has a flange, the end-surface of which rests against the main housing part. It is furthermore provided in a variant that at least one housing or socket cap with a cap opening for fitting onto the inlet or outlet is provided, the housing cap preferably being screwable to a housing part, for example the main housing part.

This screw connection can take place for example with the help of self-tapping screws which can be screwed into corresponding bores in a housing part. This has the advantage that, when producing the housing part in which the screws are to engage, no thread need be cut, but a corresponding bore must merely be introduced. Through this measure it is possible to produce all of the housing parts for example by injection moulding. The necessary thread is then formed by using the self-tapping screw during the screwing of the housing cap to the corresponding housing part.

In a particularly preferred version, the housing cap has a substantially flat cap base and an adjoining substantially cylindrical extension with a conical outer surface. The pressure zone ring also has, at least sectionwise, a substantially conical inner surface which corresponds to the conical outer surface of the cylindrical extension such that the valve sleeve can be clamped between the conical outer surface of the cylindrical continuation on the one hand and conical inner surface of the pressure zone ring on the other.

It is understood that the conical inner surface and/or the conical outer surface can also be designed stepped, i.e. comprise several sections with different internal and external diameters.

Further advantages, features and possible uses of the present invention are illustrated with the help of the following description of a preferred version and the associated figures. There are shown in:

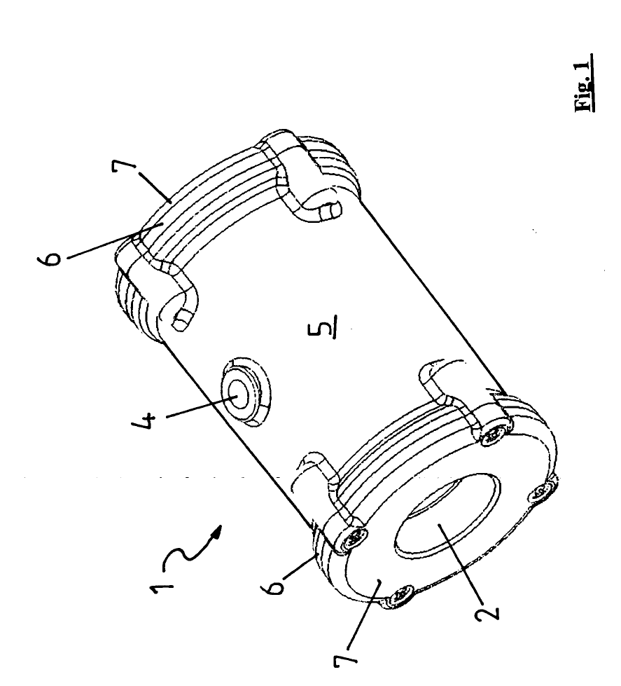

FIG. 1 a perspective view of a pinch valve according to the invention,

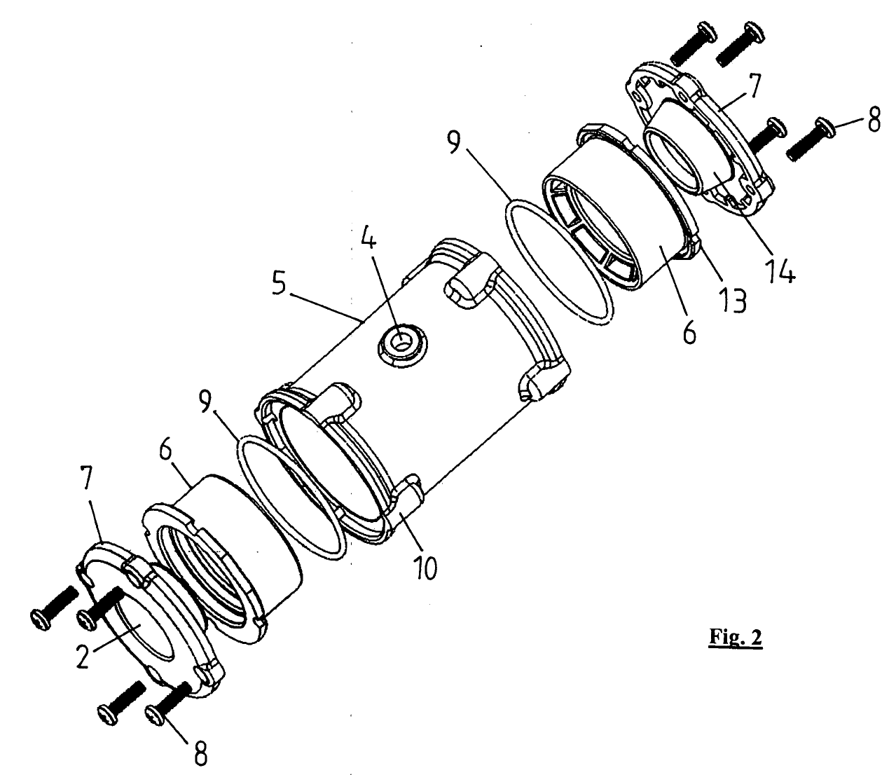

FIG. 2 a perspective exploded view of the pinch valve of FIG. 1,

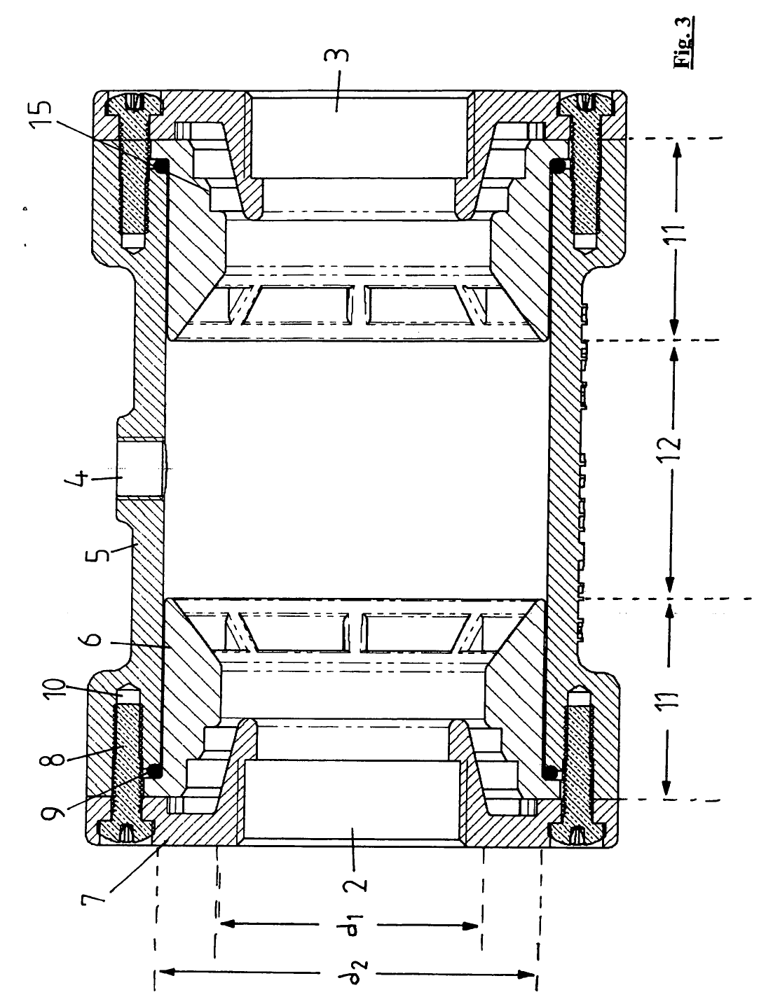

FIG. 3 a longitudinal section view of the pinch valve according to the invention of FIG. 1 and

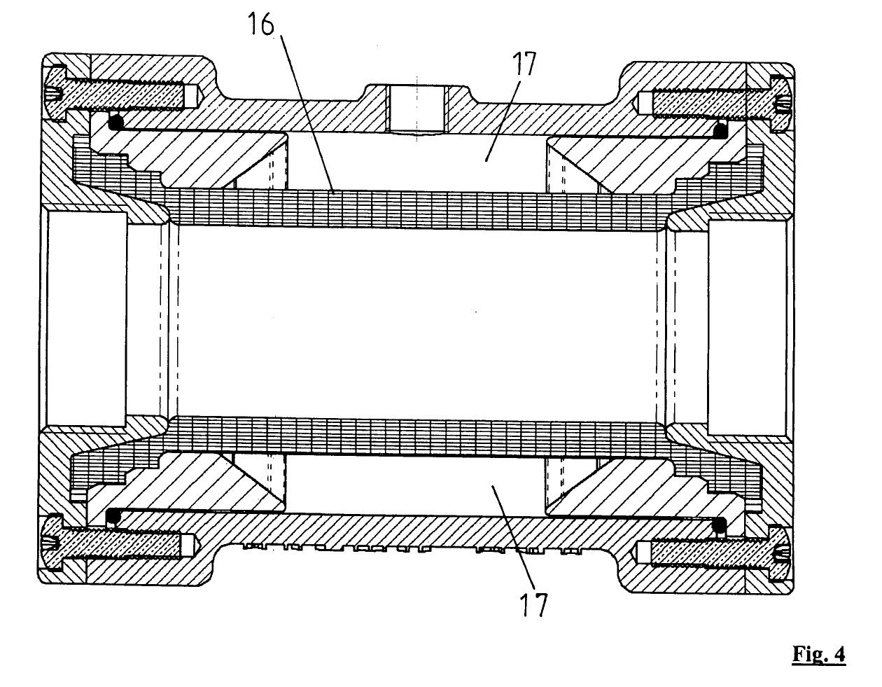

FIG. 4 a longitudinal view as in FIG. 3, but with inserted valve sleeve.

FIG. 1 shows a perspective view of a pinch valve 1 according to the present invention. The pinch valve 1 has an inlet 2 and an outlet 3 and also a control opening 4. Inlet 2 and outlet 3 are connected to each other via a valve sleeve 16 (shown only in FIG. 4). If a pressure medium, for example in the form of compressed air, is applied to the control connection 4, the valve sleeve 16 is compressed and the channel cross-section between inlet 2 and outlet 3 is closed or at least reduced. The pinch valve 1 has a main housing part 5, two pressure zone rings 6 and two socket caps 7.

The individual parts of the pinch valve 1 can be seen more clearly in the exploded view of FIG. 2. It can be seen that the pinch valve 1 consists of a substantially cylindrical main housing part 5 into which a pressure zone ring 6 is inserted at each end surface. The pressure zone ring 6 likewise has a substantially cylindrical shape and has a flange 13. The pressure zone ring is designed such that it can be inserted into the end-surface openings of the main housing part 5. In order to seal off the pressure zone ring 6 vis-á-vis the main housing part 5, an O-ring 9 is provided the end-surface of which abuts the main housing part 5 on the one hand and against the flange 13 of the pressure zone ring 6 on the other. By inserting the pressure zone ring 6 into the main housing part 5, sections of the inner passage cross-section of the valve housing, which is formed by the main housing part 5 and the two pressure zone rings 6,-are reduced in size.

The pressure zone ring 6 is secured to the main housing part 5 with the help of the socket caps 7. The socket caps 7 have a cap base surface and also a conical projection 14 extending away from same. Bores through which the screws 8 engage in corresponding bores 10 in the main housing part 5 are introduced into the cap base surface of the cap 7. Here, the screws 8 are designed as self-tapping screws with the result that, after the pressure zone ring 6 has been inserted into the end-surface openings of the main housing part 5 with the O-ring 9 interposed, the cap 7 can be inserted into the pressure zone ring 6 and can be screwed to same with the help of the self-tapping screws 8 which engage in the bores in the main housing part 5 through the bores in the cap 7.

This version has the advantage that all the parts of the housing can be produced without great outlay, for example by injection moulding, as—unlike the valve housings of the state of the art—no housing part has an undercut. Injection moulding is a very economical process, as a final working of the demoulded pre-shaped parts is not necessary in most cases.

The cooperation of the individual housing parts is shown more clearly with reference to FIG. 3 which gives a perspective section view of the pinch valve according to the invention.

The main housing part 5, into which the pressure zone rings 6 have been inserted, can be seen. An O-ring 9 is arranged between the flange 13 of the pressure zone ring 6 and the end-surface of the main housing part 5. The pressure zone ring 6 has a substantially cylindrical outer surface. The inner surface of the pressure zone ring 6 widens both in the direction of the main housing part 5 and in the direction of the inlet or outlet. The widening inner surface of the pressure zone ring 6 corresponds substantially to the conical outer surface of the conical projection 14 of the housing cap 7, with the result that the valve sleeve (not shown) can be clamped between the outer surface of the conical projection 14 of the housing cap 7 on the one hand and the conically widening inner surface 15 of the pressure zone ring 6.

It is understood that the conical surfaces can also be designed stepped, as shown in FIG. 3 using the example of the conically widening inner surface 15 of the pressure zone ring 6. The only important thing is to form the two surfaces so that the valve sleeve is held securely between housing cap 7 and pressure zone ring 6 when the housing cap is fitted.

The advantage of the illustrated, stepped version is that the valve sleeve 16 can be held very securely even upon application of higher pressures. In principle, the outer surface of the conical projection 14 could also be formed stepped, but it has been demonstrated that when the valve is mounted it is advantageous if the conical projection 14 has no steps, as the socket cap 7 can then be inserted more easily into the valve sleeve 16 and the pressure zone ring 6.

It can also be seen in FIG. 3 that in the illustrated version the inner surface of the pressure zone ring 6 also widens in the direction of the main housing part. This has the advantage that if, in the pressureless state, i.e. when pressure is not applied to the control opening, the valve sleeve bulges due to the pressure of the product flow, the valve sleeve is not damaged when it comes into contact with a sharp-edged corner of the pressure zone ring 6.

It can clearly be seen in FIG. 3 that the pinch valve 1 has a housing section 12 with a larger passage cross-section d₂ and two housing sections 11 with a smaller passage cross-section d₁.

This measure ensures that the valve sleeve 16 is mounted such that a valve channel forms which has a substantially constant channel cross-section.

FIG. 4 shows a further longitudinal section through the pinch valve. This figure differs from FIG. 3 merely in that the valve sleeve 16 is now represented. It becomes clear in this representation that there is a substantially annular control space 17 between the valve sleeve 16 and the inner wall of the housing section with a larger passage cross-section.

### LIST OF REFERENCE NUMBERS

1 Pinch valve

2 Inlet

3 Outlet

4 Control opening

5 Main housing part

6 Pressure zone ring

7 Socket cap

8 Screws

9 O-ring

10 Bores

11 Housing section with smaller passage cross-section

12 Housing section with larger passage cross-section

13 Flange

14 Extension

15 Inner surface

16 Valve sleeve

17 Control space

1. Pinch valve (1) with a housing which has an inlet (2), an outlet (3) and a control opening (4) for connection to a pressure medium, wherein the inlet and outlet are connected to each other via a passage, the passage having at least two sections with different cross-section (12), and a valve sleeve (16) which is connected to the inlet and outlet and arranged such that it forms a valve channel between inlet and outlet, wherein, upon actuation of the control opening (4) with a pressure medium, the valve sleeve (16) moves such that the channel cross-section between inlet and outlet is reduced or closed, characterized in that the housing is formed in at least two parts, one housing part forming the section with a smaller passage cross-section and the other housing part the section with a larger passage cross-section.

2. Pinch valve (1) according to claim 1, characterized in that the housing has at least three sections, one with a larger passage cross-section and two with a smaller passage cross-section, the sections with the smaller passage cross-section preferably being arranged in the area of the inlet (2) and outlet (3), and in that the housing is formed in at least three parts, two housing parts forming the sections with a smaller passage cross-section and the third housing part forming the section with a larger passage cross-section.

3. Pinch valve (1) according to claim 1 or 2, characterized in that the housing is made of a substantially cylindrical main housing part (5) and at least one pressure zone ring (6), the pressure zone ring (6) being at least partly insertable into the main housing part (5).

4. Pinch valve (1) according to one of claims 1 to 2, characterized in that in the pressureless state of the control connection the valve channel formed by the valve sleeve (16) has a substantially constant channel cross-section between inlet and outlet.

5. Pinch valve (1) according to one of claims 1 to 2, characterized in that a substantially annular control space (17) to which pressure can be applied via the control opening (4) is located in the area of the housing section (11) with the larger passage cross-section between the valve sleeve (16) on the one hand and the housing on the other.

6. Pinch valve (1) according to one of claims 1 to 2, characterized in that at least the housing part which forms the section with a smaller passage cross-section is made of plastic.

7. Pinch valve (1) according to claim 6, characterized in that the whole housing is made of plastic.

8. Pinch valve (1) according to one of claims 1 to 2, characterized in that the housing parts (11) are sealed against each other.

9. Pinch valve (1) according to claim 3, characterized in that the pressure zone ring (6) has a flange (13), the end-surface of which rests against the main housing part.

10. Pinch valve (1) according to one of claims 1 to 2, characterized in that at least one socket cap (7) with a cap opening for fitting onto the inlet or outlet is provided.

11. Pinch valve (1) according to claim 10, characterized in that the socket cap can be screwed to a housing part, preferably to the main housing part (5).

12. Pinch valve (1) according to claim 11, characterized in that the socket cap can be screwed to the housing part with the help of self-tapping screws that can be screwed into corresponding bores in a housing part.

13. Pinch valve (1) according to claim 10, characterized in that the housing cap has a substantially flat cap base and an adjoining substantially cylindrical projection with conical outer surface.

14. Pinch valve (1) according to claim 13, characterized in that the pressure zone ring (6) has, at least sectionwise, a substantially conical inner surface (15) which corresponds to the conical outer surface of the projection (14), the conical surfaces being formed such that the valve sleeve (16) can be clamped between the conical outer surface of the projection (14) on the one hand and the conical inner surface (15) of the pressure zone ring (6) on the other.

15. Pinch valve according to one of claims 1 to 2, characterized in that the control connection (4) is arranged in the section with the larger passage cross-section.

16. Pinch valve according to claim 6, wherein the plastic is a thermoplastic material.

17. Pinch valve according to claim 16, wherein the thermoplastic material is a polyoxymethylene homo- or copolymerizate.

18. Pinch valve according to claim 6, wherein the plastic is a thermoplastic material.

19. Pinch valve according to claim 18, wherein the thermoplastic material is a polyoxymethylene homo- or copolymerizate.
